(19) United States
(12) Patent Application Publication
(10) Pub. No.: US 2025/0121367 A1
(43) Pub. Date: Apr. 17, 2025

(54) Method for Sealing Microfluidic Structures by Means of a Hybrid-Foil Membrane

(71) Applicant: Creganna Unlimited Company, Ballybrit, Galway (IE)

(72) Inventors: Luis FERNANDEZ LEDESMA, Guipuzcoa (ES); Andreu LLOBERA ADAN, Guipuzcoa (ES); Irene VARELA LENIZ, Guipuzcoa (ES); Pablo GARCÍA DE MADINABEITIA MERINO, Guipuzcoa (ES); Lorea ORIA MARTINEZ, Guipuzcoa (ES)

(73) Assignee: Creganna Unlimited Company, Ballybrit, Galway (IE)

(21) Appl. No.: 18/685,241

(22) PCT Filed: Jul. 28, 2022
(86) PCT No.: PCT/EP2022/071161

§ 371 Date: Feb. 21, 2024

(30) Foreign Application Priority Data
Aug. 27, 2021 (EP) 21382785.0

(51) Int. Cl. B01L 3/00

(52) U.S. Cl. CPC B01L 3/502707; B01L 2200/0689; B01L 2300/0887; B01L 2300/123

(57) ABSTRACT

The present invention relates to a method for sealing one or more microfluidic structures, preferably patterned over a polymer substrate (1), by means of a hybrid-foil membrane (2). The hybrid-foil membrane (2) advantageously comprises two layers (3, 4) having different mechanical properties and, preferably, different rigidity and/or stiffness values. Preferably, the foil comprises one flexible and elastic layer (3) bound to a rigid, and mechanically stable layer (4). Moreover, the thickness of elastic layer (3) is equal to or greater than the roughness dimension of the substrate (1) to be sealed. Thanks to this configuration, the hybrid-foil membrane (2) adapts to the surface of the substrate (1), while conferring enough mechanical stability under pressure-induced microfluidic structure deformation. This positively affects both the sealing and functionality of the resulting microfluidic device.

### FIELD OF THE INVENTION

The present invention relates to the technical field of polymer films for sealing microfluidic structures. More specifically, the invention relates to a method for sealing any type of microfluidic channel or geometry, preferably patterned over a polymer substrate, by means of a hybrid-foil membrane arranged on said substrate.

### BACKGROUND OF THE INVENTION

Microfluidics has become a dominant field in many scientific and industrial contexts for developing fluid-handling technologies on the micro- and nanometre scales. It is widely applied to many activities, such as chemical and biological analysis, environmental monitoring, and quality control. In this context, the production of microfluidic devices requires fabricating different classes of microstructures for containing, manipulating, controlling, or conducting fluids within miniaturized systems, typically comprising channels, reaction chambers, hybridization chambers, pumps, and valves. The advantages of such microfluidic devices, also referred to as “lab-on-a-chip” devices, include the need of low volumes of samples and reagents, shortened analysis times, easy use, high scalability for mass production and screening, and a large degree of control over the performed processes.

Microfluidic devices are fabricated from a variety of materials that require a range of different processing steps. The first material used was silicon, due to its resistance to organic solvents, easy deposition of metals on it, superior thermal conductivity, and surface stability. However, its opacity to visible light, its expensive fabrication based on photolithography or wet/dry etching methods, and the difficulty to create microfluidic components from it, made silicon to be quickly replaced by glass. Glass presents the following additional advantages over silicon: optical transparency at visible wavelengths, excellent high-pressure resistance, biocompatibility, and no chemical reactivity. The main hurdle to overcome continues being the rather high production cost, even though prices have been significantly reduced with respect to silicon. This limitation was the origin of the development of low-cost and disposable polymer-based microfluidic devices, mainly based on polydimethylsiloxane (PDMS) and thermoplastics.

PDMS is the material of choice for fast prototyping microfluidic devices because of its low cost and ease production. PDMS has good optical transparency in the UV-NIR range and withstands temperatures up to 250° C. It is flexible and can easily be adhered to other materials, which make it convenient for complex microfluidics designs by multilayer soft lithography (i.e., valves, pumps, and micro-mixers). Its non-toxicity and high gas permeability can be advantageous in cellular studies and long-term experiments. Among the main disadvantages of PDMS microfluidic devices are its hydrophobic nature, low solvent and acid/base resistivity, nonspecific protein adsorption (necessitating in some cases surface modification), limitations in channels geometries due to its elasticity (i.e., shrinking or sagging), and lack of stability due to pressure-induced channel deformation.

Thermoplastic polymers, mostly polystyrene (PS), polycarbonate (PC), polymethylmethacrylate (PMMA), polyvinyl chloride (PVC), polyimide (PI), and the family of cyclic olefin polymers (i.e., cyclic olefin copolymer (COC), cyclic olefin polymer (COP), and cyclic block copolymer (CBC)), have emerged as an excellent option for commercially viable industrial-scale production of microfluidic devices. Thermoplastics are rigid polymer materials characterized by good mechanical stability over a wide range of operational temperatures and pressures, low water-absorption percentage, and organic-solvent and acid/base resistivity, which are critical factors in many bioanalytical microfluidic applications. Thermoplastic micro-patterned structures can be created massively by replication processes, including hot embossing, roller imprinting, thermoforming, and injection moulding.

The fabrication of both PDMS and thermoplastics microfluidic devices are mainly based on the fabrication of two substrates that must be effectively sealed to encapsulate the microchannels or other closed architectures fabricated in one or both substrates. This sealing method is a critical step towards a fully assembled and functional device, since it defines the bonding strength, geometry stability, optical transparency in the UV-NIR, and surface chemistry of the produced microfluidic device. Unlike PDMS bonding, thermoplastic bonding often represents a technical challenge, as the contact area between two rigid materials is smaller due to inherent roughness. This causes defects on the sealing, resulting in leakages in most cases.

Generally, thermoplastic bonding is achieved either by direct bonding or by an intermediate bonding approach. Direct bonding is a bonding process that uses no intermediate material at the bonding interface, such as thermal fusion bonding, ultrasonic welding, surface modification, and solvent bonding. Alternatively, indirect bonding involves the use of an intermediate material to assist in the bonding by increasing the effective contact area between both substrates, such as glues, epoxies, acrylates and even an elastomer layer, like PDMS. However, from a mass production point of view, indirect bonding is not desirable in terms of operating cost and time as it implies an additional step in the manufacturing process.

In other cases, an elastomeric layer is used as the only structural material of one of the two pieces required for the manufacturing of microfluidic devices. However, the lack of mechanical stability of the final device represents a serious problem, leading to channel deformation while manipulation.

The present invention proposes a solution to the technical problems mentioned above, by means of a novel method that allows to overcome the state of the art of both the sealing and the mechanical stability in microfluidic devices.

### BRIEF DESCRIPTION OF THE INVENTION

A first object of the present invention relates to a method for sealing one or more microfluidic structures patterned over a base substrate by means of a hybrid-foil membrane arranged on said base substrate.

Advantageously, the method of the invention comprises performing the following steps:
a) forming a hybrid-foil membrane by joining a first layer and a second layer, wherein:
   the first layer comprises a flexible and elastic material with a Young's modulus between 300 kPa and 150 MPa;
   the second layer comprises a rigid and mechanically stable material with a Young's modulus between 150 MPa and 3.5 GPa; and,
   the first layer has a thickness value (T) equal to or greater than the roughness dimension (R) of the base substrate;
b) arranging the hybrid-foil membrane on the base substrate; and,
c) sealing the microfluidic structure/s patterned over the base substrate by applying a physical and/or chemical treatment to the base substrate and the hybrid-foil membrane, obtaining then a fully assembled microfluidic device.

Under the scope of interpretation of the present invention, the expression “roughness dimension” will be understood as the maximum distance between the peaks and the valleys (also referred to as “irregularities”) forming the surface of the base substrate at the microscale.

This configuration of the hybrid-foil membrane positively affects both the sealing and functionality of the resulting microfluidic device. Thanks to the different stiffness of the materials that form each of its layers and the defined thickness of the elastic layer, the hybrid-foil membrane adapts to the surface of the base substrate. This causes an effective bonding between the membrane and the substrate (as the membrane fills the space comprised between the superficial irregularities of the substrate), while conferring sufficient mechanical stability to that bonding.

In a preferred embodiment of the invention, the Young's modulus of the first layer is between 300 kPa and 60 MPa, and/or the Young's modulus of the second layer is between 1.5 GPa and 3.5 GPa.

In another preferred embodiment of the invention, the Poisson's coefficient of the first layer is between 0.43 and 0.50, and/or wherein the Poisson's coefficient of the second layer is between 0.35 and 0.43.

In a further preferred embodiment of the invention, the step of joining the first and second layers of the hybrid-foil membrane is made by co-extrusion, thermal fusion bonding, ultrasonic welding, surface modification, and/or solvent bonding.

In yet another preferred embodiment of the invention, the physical and/or chemical treatment applied to the base substrate and the hybrid-foil membrane comprises one or more of: co-extrusion, thermal fusion bonding, ultrasonic welding, surface modification, solvent bonding.

In yet another preferred embodiment of the invention, the first layer comprises an elastomer, preferably, polydimethylsiloxane (PDMS), cyclic olefin copolymer elastomer E-140, agar-agar, or any combination thereof.

In yet another preferred embodiment of the invention, the second layer comprises a thermoplastic, preferably, polyamide (PA), polycarbonate (PC), polyethylene terephthalate (PET), polymethylmethacrylate (PMMA), polystyrene (PS), polypropylene (PP), cyclic olefin copolymer (COC), cyclic olefin polymer (COP), or any combination thereof.

In yet another preferred embodiment of the invention, the thickness of the first layer is between 1 μm and 500 μm, preferably between 5 μm and 250 μm or, more preferably, between 10 μm and 200 μm, to maximize the contact area between the surfaces of both layers during the formation of the hybrid-foil membrane.

In yet another preferred embodiment of the invention, the thickness of the second layer is between 20 μm and 25 mm, preferably between 40 μm and 2 mm or, more preferably, between 100 μm and 1.5 mm, to ensure the mechanical stability of the resulting microfluidic device.

In yet another preferred embodiment of the invention, the second layer of the hybrid-foil membrane is bonded to further layers, which are stacked over said second layer prior to the sealing of the microfluidic structure patterned over the base substrate.

In yet another preferred embodiment of the invention, the total number of layers of the hybrid-foil membrane is between 1 and 10, preferably between 1 and 6, or more preferably, between 1 and 4.

A second object of the invention relates to a microfluidic device comprising a microfluidic structure patterned over a base substrate and sealed with a hybrid-foil membrane arranged on said base substrate, wherein the hybrid-foil membrane comprises a first layer and a second layer, and:
the first layer comprises a flexible and elastic material with a Young's modulus between 300 kPa and 150 MPa;
the second layer comprises a rigid and mechanically stable material with a Young's modulus between 150 MPa and 3.5 GPa;
the first layer has a thickness value (T) equal to or greater than the roughness dimension (R) of the base substrate;
   and wherein the microfluidic device is directly obtainable according to any of the methods herein described.

In a preferred embodiment of the invention, the Young's modulus of the first layer of the hybrid-foil membrane is between 300 kPa and 60 MPa, and/or the Young's modulus of the second layer of the hybrid-foil membrane is between 1.5 GPa and 3.5 GPa.

A third object of the invention relates to a microfluidic device comprising two microfluidic structures bonded through a hybrid-foil membrane arranged therebetween, wherein each of said microfluidic structures is patterned over a corresponding base and secondary substrate and the hybrid-foil membrane comprises a first layer and a second layer, wherein:
the first layer comprises a flexible and elastic material with a Young's modulus between 300 kPa and 150 MPa;
the second layer comprises a rigid and mechanically stable material with a Young's modulus between 150 MPa and 3.5 GPa;
the second layer is bonded to an extra layer that comprises a flexible and elastic material with a Young's modulus between 300 kPa and 150 MPa;
the first layer has a thickness value (T) equal to or greater than the roughness dimension (R) of the base substrate;
the extra layer has a thickness value (T′) equal to or greater than the roughness dimension (R′) of the secondary substrate;
   and wherein the microfluidic device is directly obtainable according to any of the methods described above.

In a preferred embodiment of the invention, the Young's modulus of the first layer of the hybrid-foil membrane and/or the extra layer is between 300 kPa and 60 MPa, and/or wherein the Young's modulus of the second layer of the hybrid-foil membrane is between 1.5 GPa and 3.5 GPa.

### DESCRIPTION OF THE FIGURES

FIG. 1 shows a profile view of the hybrid-foil membrane of the invention in one of its preferred embodiments, which comprises two polymeric layers, one made of a thermoplastic, and the other of an elastomer.

FIGS. 2a and 2b show the traditional sealing process of a substrate with an elastomeric foil by direct bonding.

FIGS. 3a and 3b show the traditional sealing process of a substrate with a thermoplastic foil by direct bonding.

FIG. 4 shows a profile view of the hybrid-foil membrane of the invention in one of its preferred embodiments, wherein the thermoplastic layer of the membrane is bonded to an extra layer for creating a functional and mechanically stable microfluidic device by sealing two substrates with microfluidic architectures patterned over at least one of them.

### NUMERICAL REFERENCES USED IN THE DRAWINGS

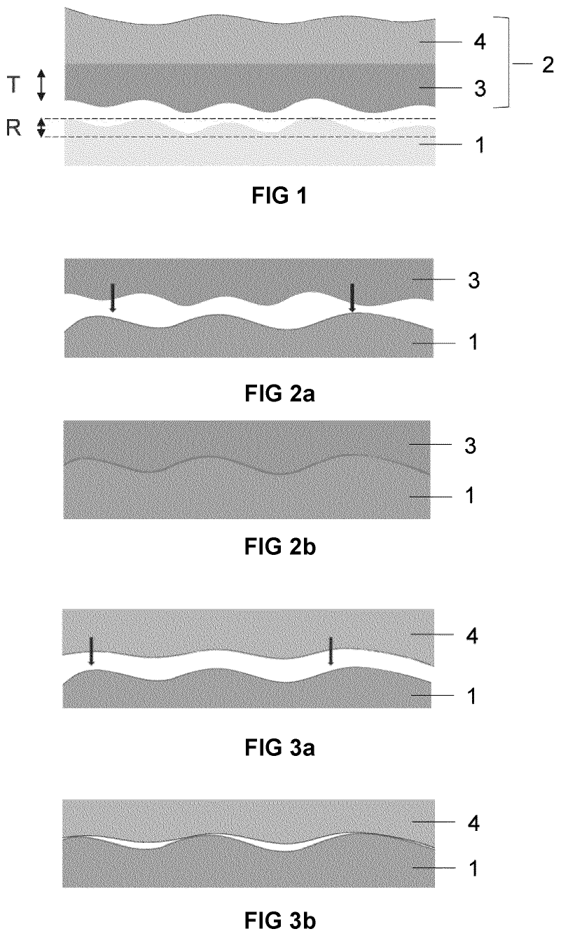

In order to provide a better understanding of the technical features of the invention, the referred FIGS. 1-4 are accompanied of a series of numerical references which, with an illustrative and non-limiting character, are hereby represented:

| | |
|---|---|
| 1 | Base substrate |
| 2 | Hybrid-foil membrane |
| 3 | First layer, flexible/elastic layer |
| 4 | Second layer, rigid/mechanically stable layer |
| 5 | Extra layer/s |
| 6 | Secondary substrate |

### DETAILED DESCRIPTION OF THE INVENTION

As described in preceding paragraphs, one object of the present invention relates to a method for sealing a microfluidic structure, preferably patterned over a polymer base substrate (1), by means of a hybrid-foil membrane (2) (FIG. 1). To do so, the hybrid-foil membrane (2) advantageously comprises two layers (3, 4) having different mechanical properties and, preferably, different rigidity and/or stiffness values. As a result, the hybrid-foil membrane (2) adapts to the base substrate (1), not only providing an effective bonding between them (i.e., completely filling the space comprised between the superficial irregularities of the base substrate (1)), but also ensuring that the mechanical stability of the arrangement formed by the base substrate (1) and the hybrid-foil membrane (2) is preserved in the final microfluidic device.

In a preferred embodiment of the invention, the hybrid-foil membrane (2) comprises a first layer (3) and a second layer (4), wherein the first layer (3) has a thickness value (T) equal to or greater than the roughness dimension (R) of the base substrate (1) whereon the hybrid-foil membrane (2) is to be arranged. As previously described, the expression “roughness dimension” will be herein understood as the maximum distance between the peaks and the valleys (also referred to as “irregularities”) forming the surface of the base substrate (1) at the microscale.

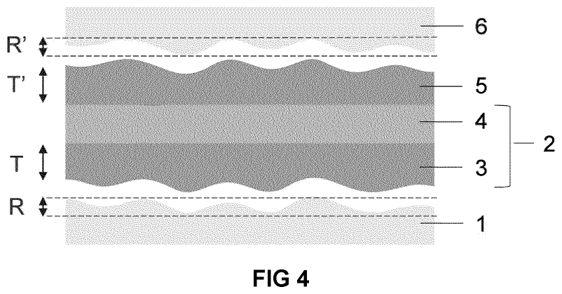

Unlike the approach of the present invention, prior-art known techniques have been based on using only a single rigid or elastic layer for sealing microchannels or other closed architectures fabricated in a base substrate (1), but never two layers of different mechanical properties in combination. Disadvantageously in the prior art, using only one elastic/flexible layer (3) (FIGS. 2a and 2b) can lead to an effective bonding between said layer (3) and the base substrate (1), but it will normally be mechanically unstable (leading to, for example, channel deformation while manipulation). On the other hand, using only a rigid layer (4) (FIGS. 3a and 3b) can lead to a mechanically stable bonding between said layer (4) and the base substrate (1), but said layer (4) will not be able to completely fill the space comprised between the superficial irregularities of the base substrate (1).

In a more preferred embodiment of the invention, the first layer (3) of the hybrid-foil membrane (2) comprises a flexible and elastic material with a Young's modulus between 300 kPa and 150 MPa, more preferably between 300 kPa and 60 MPa, whereas the second layer (4) is made of a rigid and mechanically stable material with a Young's modulus between 150 MPa and 3.5 GPa, more preferably between 1.5 GPa and 3.5 GPa. Their corresponding Poisson's coefficient will be, more preferably, between 0.43 and 0.50 for the first layer (3), and between 0.35 and 0.43 for the second layer (4).

Under these embodiments, the first layer (3) of the hybrid-foil membrane (2) can be made of different materials, preferably elastomeric, and more preferably of polydimethylsiloxane (PDMS), cyclic olefin copolymer elastomer E-140 or agar-agar. The second layer (4) can be made of different thermoplastic materials, although preferably, it will be fabricated by means of deposition of polyamide (PA), polycarbonate (PC), polyethylene terephthalate (PET), polymethylmethacrylate (PMMA), polystyrene (PS), polypropylene (PP), cyclic olefin copolymer (COC), cyclic olefin polymer (COP), and/or a similar thermoplastic material.

The thickness of the first layer (3) is typically comprised between 1 μm and 500 μm, preferably between 5 μm and 250 μm and, more preferably, between 10 μm and 200 μm. The thickness of the second (4) layer is typically comprised between 20 μm and 25 mm, preferably between 40 μm and 2 mm; and more preferably, between 100 μm and 1.5 mm.

The first (3) and second (4) layers forming the hybrid-foil membrane (2) can be joined by any suitable bonding means or process, such as co-extrusion, pressure bonding, thermal fusion bonding, ultrasonic welding, surface modification or solvent bonding. After said joining process, both layers (3, 4) form a single structure (2) which is ready for sealing microchannels or other closed architectures fabricated in a base substrate (1).

More specifically, the method of the invention for sealing either a single microfluidic structure or a plurality of them, preferably patterned over a polymer base substrate (1), by means of a hybrid-foil membrane (2), comprises the following steps:
a) forming a hybrid-foil membrane (2) by joining the first layer (3) and the second layer (4);
b) arranging the hybrid-foil membrane (2) on the base substrate (1); and,
c) sealing the microfluidic structure/s by applying a physical and/or chemical treatment to the base substrate (1) and the hybrid-foil membrane (2).

The different stiffness of the first (3) and second (4) layers comprised in the hybrid-foil membrane (2) provides enough elasticity to adapt to the surface of the base substrate (1) and confers enough mechanical stability under pressure-induced microfluidic structure deformation. This feature positively affects not only the effectivity of the sealing, but also the functionality of the fully assembled microfluidic device.

In a further preferred embodiment of the invention, the second (4) layer of the hybrid-foil membrane (2) can be bonded to further layers (5), which can be stacked over said second layer (4) prior to the sealing of the microfluidic structure/s patterned over the base substrate (1). These extra layers (5) can be used either for conferring additional mechanical properties to the fully assembled microfluidic device or for creating a functional and mechanically stable microfluidic device from the bonding of two substrates (1, 6). In this latter scenario (FIG. 4), the extra layer (5) in contact with the secondary substrate (6):
has a thickness value (T′) equal to or greater than the roughness dimension (R′) of the secondary substrate (6); and
comprises a flexible and elastic material with a Young's modulus between 300 kPa and 150 MPa, or, more preferably between 300 kPa and 60 MPa.

The total number of extra layers (5) that can be stacked over and bonded to the rigid layer (4) of the hybrid-foil membrane (2) under this embodiment is preferably between 1 and 10, more preferably, between 1 and 6 and, even more preferably, between 1 and 4.

1-15. (canceled)

16. A method for sealing a microfluidic structure patterned over a base substrate by means of a hybrid-foil membrane arranged on said base substrate, the method comprising:
a) forming the hybrid-foil membrane by joining a first layer and a second layer, wherein:
the first layer comprises a flexible and elastic material with a Young's modulus between 300 kPa and 150 MPa;
the second layer comprises a rigid and mechanically stable material with a Young's modulus between 150 MPa and 3.5 GPa;
the first layer has a thickness value equal to or greater than the roughness dimension of the base substrate;
b) arranging the hybrid-foil membrane on the base substrate; and,
c) sealing the microfluidic structure by applying a physical and/or chemical treatment to the base substrate and the hybrid-foil membrane.

17. The method as recited in claim 16, wherein the Young's modulus of the first layer is between 300 kPa and 60 MPa, and/or wherein the Young's modulus of the second layer is between 1.5 GPa and 3.5 GPa.

18. The method as recited in claim 16, wherein the Poisson's coefficient of the first layer is between 0.43 and 0.50, and/or wherein the Poisson's coefficient of the second layer is between 0.35 and 0.43.

19. The method as recited in claim 16, wherein the step of joining the first and second layers is made by co-extrusion, thermal fusion bonding, ultrasonic welding, surface modification, and/or solvent bonding.

20. The method as recited in claim 16, wherein the physical and/or chemical treatment applied to the base substrate and the hybrid-foil membrane comprises one or more of: co-extrusion, thermal fusion bonding, ultrasonic welding, surface modification, solvent bonding.

21. The method as recited in claim 16, wherein the first layer comprises at least an elastomer.

22. The method as recited in claim 16, wherein the second layer comprises at least a thermoplastic.

23. The method as recited in claim 16, wherein the thickness of the first layer is between: 1 μm and 500 μm, 5 μm and 250 μm, or 10 μm and 200 μm.

24. The method as recited in claim 16, wherein the thickness of the second layer is between: 20 μm and 25 mm, 40 μm and 2 mm, or 100 μm and 1.5 mm.

25. The method as recited in claim 16, wherein the second layer of the hybrid-foil membrane is bonded to further layers, which are stacked over said second layer prior to the sealing of the microfluidic structure/s patterned over the base substrate.

26. The method as recited in claim 16, wherein the total number of layers stacked over and bonded to the second layer of the hybrid-foil membrane is:
between 1 and 10;
between 1 and 6; or
between 1 and 4.

27. A microfluidic device comprising a microfluidic structure patterned over a base substrate and sealed with a hybrid-foil membrane arranged on said base substrate, wherein the hybrid-foil membrane comprises a first layer and a second layer, and:
the first layer comprises a flexible and elastic material with a Young's modulus between 300 kPa and 150 MPa;
the second layer comprises a rigid and mechanically stable material with a Young's modulus between 150 MPa and 3.5 GPa;
the first layer has a thickness value equal to or greater than the roughness dimension of the base substrate;
and wherein the microfluidic device is directly obtainable by a method according to claim 16.

28. The microfluidic device as recited in claim 27, wherein the Young's modulus of the first layer of the hybrid-foil membrane is between 300 kPa and 60 MPa, and/or wherein the Young's modulus of the second layer of the hybrid-foil membrane is between 1.5 GPa and 3.5 GPa.

29. A microfluidic device comprising two microfluidic structures bonded through a hybrid-foil membrane arranged therebetween,
wherein each of said microfluidic structures is patterned over a corresponding base and secondary substrate,
wherein the hybrid-foil membrane comprises a first layer and a second layer, and:
the first layer comprises a flexible and elastic material with a Young's modulus between 300 kPa and 150 MPa;
the second layer comprises a rigid and mechanically stable material with a Young's modulus between 150 MPa and 3.5 GPa;
the second layer is bonded to an extra layer that comprises a flexible and elastic material with a Young's modulus between 300 kPa and 150 MPa;
the first layer has a thickness value equal to or greater than the roughness dimension of the base substrate;
the extra layer has a thickness value equal to or greater than the roughness dimension of the secondary substrate;
and wherein the microfluidic device is directly obtainable by a method according to claim 25.

30. The microfluidic device as recited in claim 29, wherein the Young's modulus of the first layer of the hybrid-foil membrane and/or the extra layer is between 300 kPa and 60 MPa, and/or wherein the Young's modulus of the second layer of the hybrid-foil membrane is between 1.5 GPa and 3.5 GPa.
